(19) United States
(12) Patent Application Publication
(10) Pub. No.: US 2013/0265683 A1
(43) Pub. Date: Oct. 10, 2013

(54) CIRCUIT FOR PROTECTING AN ELECTRIC LOAD FROM OVERVOLTAGES

(71) Applicant: Michael Gueltig, Stutensee (DE)

(72) Inventor: Michael Gueltig, Stutensee (DE)

(73) Assignee: INIT Innovative Informatikanwendungen in Transport-, Verkehrs- und Leitsystemen GmbH, Karlsruhe (DE)

(21) Appl. No.: 13/994,439

(22) PCT Filed: Dec. 5, 2011
(86) PCT No.: PCT/DE2011/050052

§ 371 Date: Jun. 14, 2013

(30) Foreign Application Priority Data
Dec. 14, 2010 (DE) 10 2010 054 402.7

(51) Int. Cl. H02H 3/20

(52) U.S. Cl. CPC H02H 3/20
USPC 361/86

(57) ABSTRACT

A circuit for protecting an electric load from overvoltages has an n-channel MOSFET (metal oxide semiconductor field-effect transistor) (T1) and a means for producing a reference voltage in order to achieve the most effective overvoltage protection possible by means of the cheapest and most compact circuit possible, wherein the means for producing a reference voltage is connected to the gate of the MOSFET (T1), wherein a supply voltage is applied to the circuit on the input side and wherein the gate is supplied with a voltage greater than the supply voltage using an auxiliary voltage source in such a way that the MOSFET (T1) is turned on.

### CROSS REFERENCE TO RELATED APPLICATIONS

This application is a national stage application, filed under 35 U.S.C. §371, of International Application No. PCT/DE2011/050052, filed Dec. 5, 2011, which claims priority to and the benefit of German Application No. 10 2010 054 402.7, filed Dec. 14, 2010, the contents of both of which are hereby incorporated by reference in their entirety.

### BACKGROUND

1. Technical Field

The invention relates to a circuit for the protection of an electrical consumer against overvoltage.

2. Description of Related Art

Electrical consumers typically have a voltage range in which they can be safely operated. Below this range, the electrical consumer switches off, while above this range, there is a risk of the electrical consumer being destroyed. The cause of overvoltages is frequently a high load on the power supply—for example when a vehicle is started—or interruptions in the power supply when a failure occurs. A brief drop in voltage is commonly compensated by buffer capacitors or batteries.

The causes of overvoltages are, by way of example, lightning strikes, switching operations occurring in the supply grid, power supplies being brought online, electrostatic discharges, or sudden load drops in the supply grid. Such overvoltage triggers occur with particular frequency in the on-board power supply of vehicles. To protect against such overvoltages, typically protective circuits are connected before the electrical consumers, such that it is possible to largely overcome the problem of destruction of the electrical consumers.

Multi-stage concepts are implemented for a particularly reliable protection against overvoltage. One example of a multi-stage concept known from the prior art is illustrated in FIG. 1. The protective circuit is connected to the on-board power supply or to another voltage supply at the protective circuit input. At the output, one or more electrical consumers are connected and supplied with power. Directly at the input of the protective circuit, a varistor VDR is arranged which quickly taps out rising voltages. In this way, it is possible to limit brief ±1000 V pulses to approx. ±70 V. A subsequent diode serves as a simple protection against pole reversal, such that it is possible to catch negative overvoltages. In this way, only overvoltages with +70 V are allowed through by this point. A subsequent voltage limiting circuit A serves the purpose of reducing overvoltages further to make it possible to maintain a limit voltage. The limiting circuit A can reduce the overvoltage to 32 V, by way of example, and can function similarly to a linear regulator, converting the overvoltage into heat.

For very low currents, the voltage limit can be realized by using a bipolar transistor in voltage follower mode. Such a voltage limiting circuit is illustrated in FIG. 2. The base of the transistor is connected to a Zener diode, across which the voltage drops with a maximum of the breakdown voltage—which is 33 V in the example in FIG. 2. In this manner, the voltage is also limited at the emitter of the transistor.

The problem with this circuit is that there is a voltage drop of approx. 1 V across the limiting circuit just in normal operation. This leads on the one hand to a relatively high dissipation loss, particularly at high load currents. On the other hand, the remaining voltage reserve is reduced for the connected electrical consumer. If the protective circuit is used for example in a motor vehicle, and the supply voltage is interrupted during a starting of the vehicle, this can result in a reset of the connected devices.

A further possibility would be replacing the bipolar transistor with a MOSFET (metal oxide semiconductor field-effect transistor), the same being typically known for their minimal voltage dissipation. For example, the use of a p-channel MOSFET would be an option. However, these MOSFETS are expensive, particularly for high load currents, and the circuits take up relatively large amounts of space. By using an n-channel MOSFET, such as that illustrated in FIG. 3, it is possible to significantly reduce costs and constructed space for the protective circuit, but the voltage dissipation across the protective circuit is still significantly higher. A voltage dissipation of 2 to 3 V occurs.

Other protective circuits, such as integrated low-drop regulators for example, offer minimal voltage dissipation across the protective circuit, and have a good dynamic behavior. However, these are highly restricted in most cases due to the basic specifications, such as the possible limit voltage or the possible current load. If protection should be provided for limit voltages above 15 V only very few voltage regulators are available yet. For even higher limit voltages, or with the requirement of simple adaptability of the limit voltage, voltage regulators are completely excluded in a configuration.

The present invention therefore addresses the problem of designing and implementing a circuit of the class indicated above such that a reliable protection can be achieved against overvoltages, with minimal dissipation loss in the protective circuit, and simultaneously with the smallest possible constructed size for the protective circuit.

### BRIEF SUMMARY

According to the invention, the problem given above is addressed by the features of claim 10. According to the same, the circuit in question has an n-channel MOSFET (metal oxide semiconductor field-effect transistor) and a means for the generation of a reference voltage, wherein the means for the generation of a reference voltage is connected to the gate of the MOSFET, and a supply voltage is applied at the input of the circuit, and the gate is supplied with a voltage which is larger than the supply voltage, using an auxiliary voltage, in such a manner that the MOSFET opens.

It was first realized according to the invention that it is possible to achieve a protective circuit with a minimal voltage dissipation across the protective circuit, with relatively little increased cost and circuit complexity, even while using an n-channel MOSFET. To this end, an auxiliary voltage is used to control the gate of the MOSFET in such a manner that the MOSFET opens. In this case, it is possible to achieve particularly low voltage dissipation if the MOSFET is operated in the saturation region, and therefore is completely open.

For this purpose, a means for the generation of a reference voltage is connected to the gate of the MOSFET. The means generates a voltage which is dependent on the supply voltage at the input of the protective circuit, but which assumes at most an upper threshold which is the reference voltage. With this means, in most cases a voltage is set to ground. The reference voltage limits the voltage at the gate of the MOSFET. At the same time, the gate is connected to an auxiliary voltage source which supplies the gate with a voltage which is higher than the supply voltage applied at the input. In this way, the MOSFET is controlled beyond the linear region. In this manner, it is possible to completely take advantage of the benefits of the relatively cheap n-channel MOSFET, particularly with regard to the small constructed space and the improved transmission behavior compared to the p-channel MOSFET, without the need to accept associated high voltage dissipation across the protective circuit.

In one particularly simple embodiment of the means for the generation of the reference voltage, the same could be a Zener diode. The reference voltage is determined by the avalanche voltage of the Zener diode. Once the avalanche voltage has been exceeded, the voltage at the gate of the MOSFET is maintained at a nearly constant level.

For the purpose of improving the dynamic behavior of the protective circuit, the means for the generation of a reference voltage could be a shunt regulator. The reference electrode of the shunt regulator can interact with the output of the protective circuit via a voltage divider in such a manner that the entire protective circuit approaches the behavior of a fully integrated low-drop regulator. The voltage divider can be connected between the source of the MOSFET and the ground. The center tap can be connected to the reference electrode. In this manner, the voltage at the gate is regulated in such a manner that a desired limit voltage can be ensured across wide ranges of input voltage.

For the purpose of increasing the limit voltage—meaning the voltage which is present at the output of the protective circuit at most inside an operating range of the protective circuit—a second Zener diode can be connected in series to the shunt regulator. In this manner, the second Zener diode raises the possible reference voltage at the gate of the MOSFET to its breakdown voltage.

In one exemplary embodiment of the auxiliary voltage source, the same is a charge pump. The charge pump can be designed as single- or multi-stage, and generates an auxiliary voltage of approx. 5 V. To improve the dynamic behavior of the protective circuit, the auxiliary voltage source could be supplied from the voltage at the source of the MOSFET. In this manner, the voltage difference between the source and the gate of the MOSFET remains nearly constant, and as a result it is possible in turn to maintain a low voltage dissipation across the protective circuit almost independently of the supply voltage at the input of the protective circuit.

For the purpose of supplying the auxiliary voltage source with a voltage at the source of the MOSFET during the process wherein the protective circuit is switched on, a diode can be included which is connected to the gate of the MOSFET via an intermediate resistor. The gate is raised to a potential via the diode and the resistor, which brings the MOSFET into a conductive state. Although in this state the voltage dissipation across the MOSFET is still relatively high, the voltage at the source of the MOSFET is sufficient to supply the auxiliary voltage source. The resistor serves as a current limiter. The auxiliary voltage source builds up an auxiliary voltage which increases the voltage at the gate of the MOSFET. The gate is increasingly energized toward saturation, and the voltage dissipation across the MOSFET increasingly drops. The diode loses its function during or—at the latest—after the build-up of the auxiliary voltage, because the voltage at the gate of the MOSFET is higher than the supply voltage of the protective circuit, and therefore the diode is subjected to voltage in the blocking direction.

For the purpose of protecting the gate of the MOSFET against too high or too low voltages, a third Zener diode could be connected in parallel to the source-gate path of the MOSFET. If a gate-source voltage exceeds the breakdown voltage of the Zener diode, the excess voltage is tapped off by the Zener diode. The gate is subjected to a maximum voltage which is the source voltage plus the breakdown voltage of the Zener diode.

The protective circuit according to the invention is used in motor vehicles. The limit voltage of the circuit is above 25 V. In an exemplary manner, the limit voltage is greater than 30 V.

### BRIEF DESCRIPTION OF THE DRAWINGS

At this point, there are various options for embodying and implementing the teaching of the present invention in an advantageous manner. For this purpose, reference is hereby made first to the claims following claim 10, and second to the following description of an exemplary embodiment of the invention and to the drawings. In the context of the explanation of the exemplary embodiment of the invention and of the drawing, other generally exemplary embodiments and implementations of the teaching are explained as well, wherein:

FIG. 1 shows a schematic illustration to clarify a multi-stage concept for the protection of an electrical consumer against overvoltages,

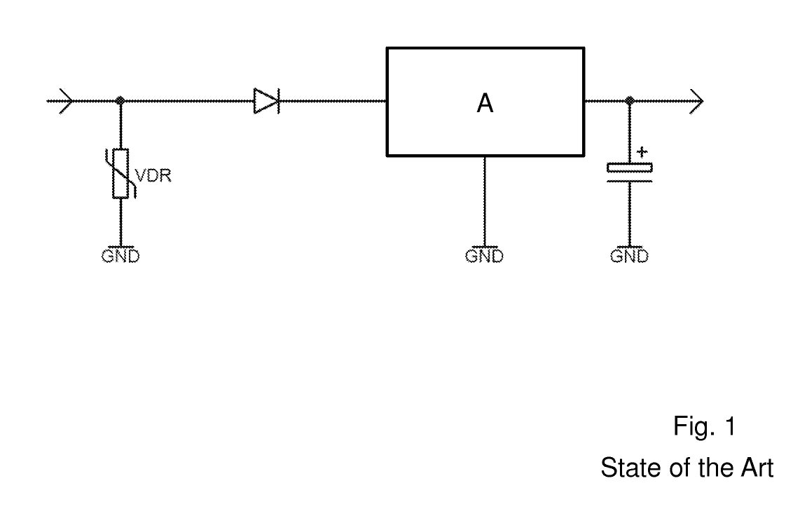

FIG. 2 shows a protective circuit according to the prior art and using a bipolar transistor,

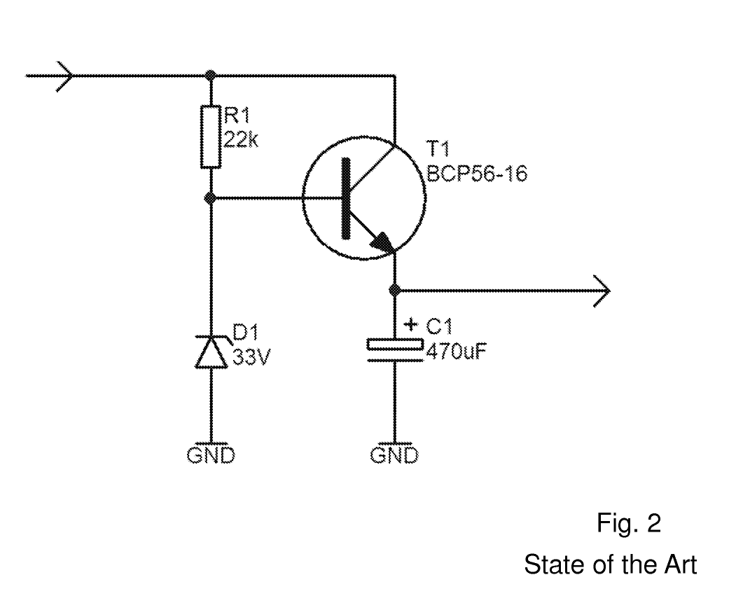

FIG. 3 shows a protective circuit according to the prior art and using an n-channel MOSFET,

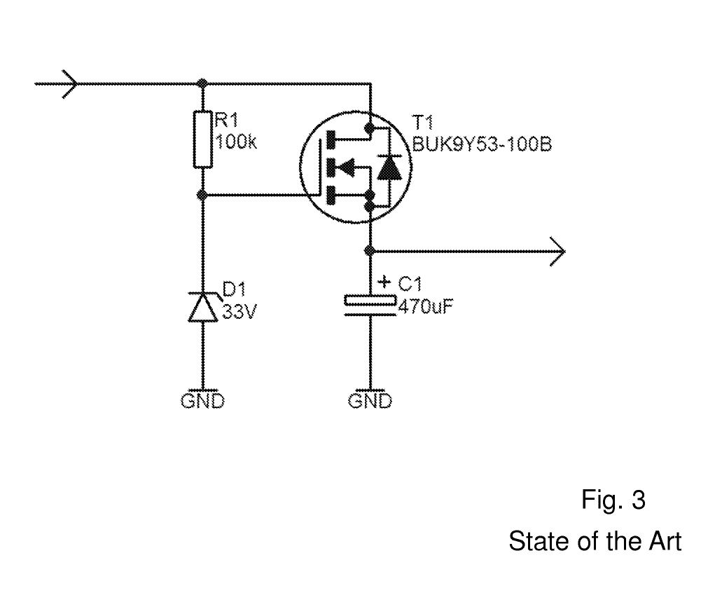

FIG. 4 shows a protective circuit according to the invention using a Zener diode as the means for the generation of a reference voltage,

FIG. 5 shows a protective circuit according to the invention using a shunt regulator as the means for the generation of a reference voltage,

FIG. 6 shows an illustration of a multi-stage protective circuit using a varistor as the coarse protection and a protective circuit according to the invention as the fine protection.

### DETAILED DESCRIPTION OF VARIOUS EMBODIMENTS

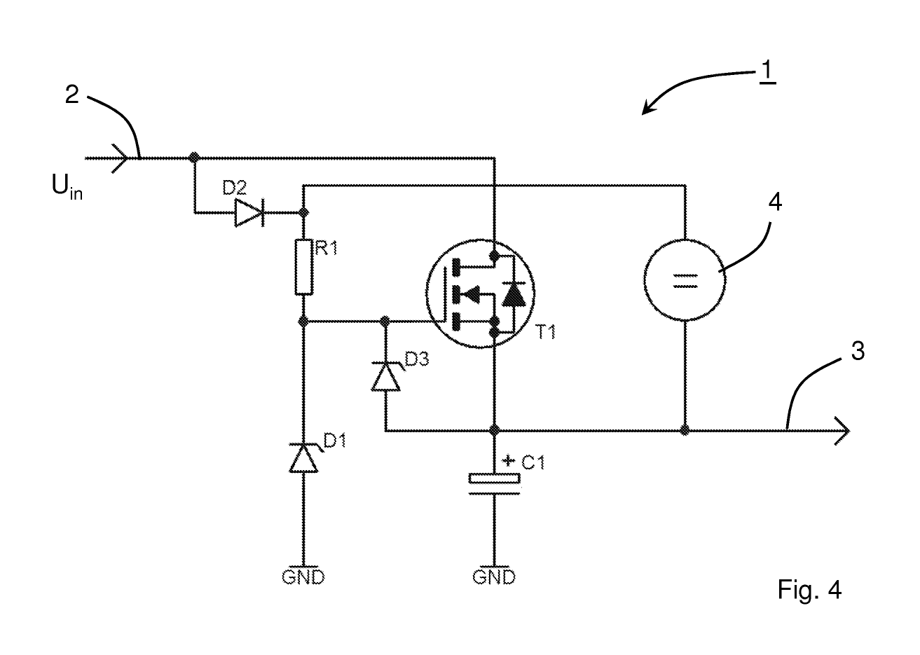

FIG. 4 shows a first embodiment of the protective circuit according to the invention. The protective circuit 1 is connected at the input 2 thereof to a voltage source, which is not included in the drawing, and is thereby supplied with a supply voltage Uᵢₙ. The input 2 is connected to the drain of an n-channel MOSFET T1. The source of the MOSFET T1 is connected to the output 3 of the protective circuit 1. The gate of the MOSFET T1 is connected to the input 2 of the protective circuit 1 via a diode D2 and a resistor R1. In this manner, the gate is supplied with a voltage following the application of the supply voltage Uᵢₙ, wherein the voltage is determined by the supply voltage Uᵢₙ, the voltage drop across the diode D2 and the voltage drop across the resistor R1. The gate is further connected via a first Zener diode D1 to ground. The first Zener diode D1 is operated in the blocking direction, such that the gate is supplied at most with a voltage which is determined by the breakdown voltage of the first Zener diode D1. In this embodiment, the first Zener diode D1 functions as the means for the generation of a reference voltage. The source of the MOSFET T1 is further connected to an auxiliary voltage source 4 which can supply the gate with a voltage which is greater than the supply voltage Uᵢₙ. The auxiliary voltage source 4 is connected to the connection point between the diode D2 and the resistor R1, by means of its second pole. A further Zener diode D3 (a third Zener diode as per the dependent claims) is connected in parallel to the source-gate path of the MOSFET T1, and serves to protect the gate of the MOSFET T1 from voltages which are too low or too high. A capacitor C1 is connected to the source of the MOSFET T1, and serves to buffer the voltage upon a loss of voltage at the input 2 of the protective circuit 1.

During operation of the circuit, a supply voltage Uᵢₙ is applied at the input 2 of the protective circuit 1. A voltage is applied at the gate of the MOSFET T1 via the diode D2 and the resistor R1, and brings the MOSFET T1 into a conductive state. A relatively high voltage drop still occurs at this point across the MOSFET T1 when in this state. The source is connected to the output 3, and supplies the connected consumer, which is not shown in FIG. 4, with electrical power. At the same time, the auxiliary voltage source 4 is supplied, and builds up an auxiliary voltage there. This raises the potential at the gate of the MOSFET T1 such that the MIOSFET [sic] T1 reaches the saturation region, or at least comes close to the saturation region. In this way, the opening resistance of the MOSFET T1 drops, and therefore the voltage drop across the MOSFET T1 drops.

The limiting circuit possesses hysteresis in the range of the supply voltage. As a result, the significant advantage exists that it is not necessary to re-open the protective circuit upon every interruption in the supply voltage. As soon as the supply voltage exceeds a certain value, the voltage behind the MOSFET is sufficient to supply the auxiliary voltage source and the potentially necessary circuiting thereof. The auxiliary voltage source begins to work and the MOSFET is opened. By way of example, if the supply voltage is interrupted when a vehicle is started, then the MOSFET remains fully open, and the subsequent circuit is protected from a reset within certain limits. Only once the circuit drops below a lower operating voltage threshold is the circuit no longer sufficient to continue to operate the protective circuit. The connected device turns off. Only once the voltage again exceeds the upper hysteresis point is the downstream electrical consumer once again supplied with power. In one exemplary configuration of the first Zener diode with a breakdown voltage of 33 V, one diode D2 with a BAV99, one resistor R1 with 100 kΩ, a second Zener diode D3 as 8V2 and a BUK9Y53-100B as the MOSFET T1, an upper hysteresis point of 7 V results, above which the circuit opens, and a lower hysteresis point of approx. 4.5 V, below which the circuit once again closes.

If an overvoltage occurs, the voltage at the gate is limited by the first Zener diode D1, and the MOSFET functions as a voltage follower. In this way, it is possible to tap off large portions of the overvoltage. In the highly simplified embodiment according to FIG. 4, however, the output voltage is dependent to a certain degree on the level of the overvoltage. In addition, individual variation in the MOSFET and the Zener diodes, as well as the temperature and the load connected at the output 3 of the protective circuit 1 have an effect on the output voltage. However, this is sufficient in many cases if the downstream electrical consumer is sufficiently voltage-proof. As such, by way of example the limit voltage can be set at a nominal 31 V, while the downstream circuit components are subjected to 38 V, and a maximum of 28 V is applied at the input during normal operation.

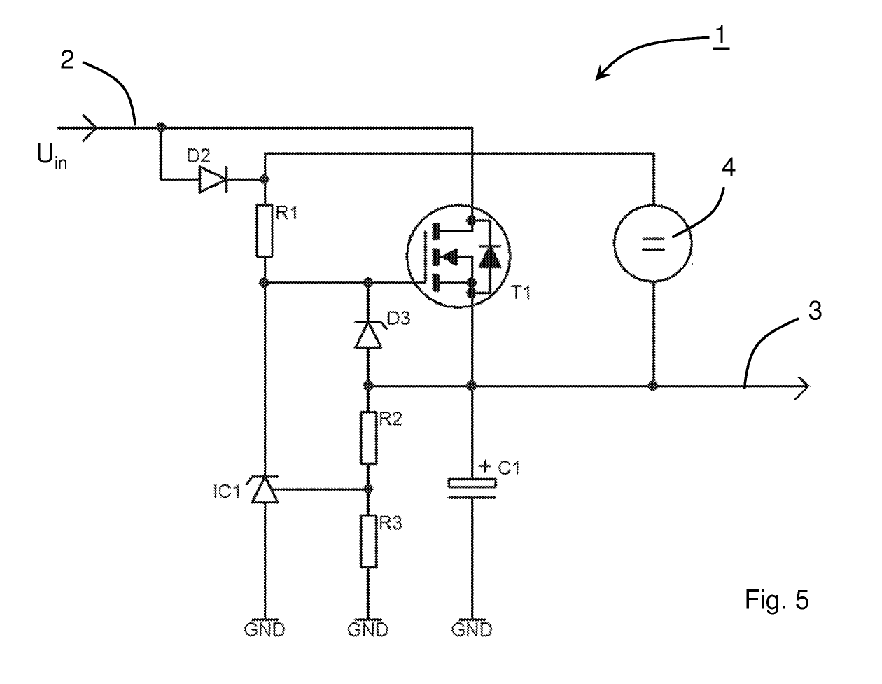

If these voltage values should be nearer to each other, the circuit can be expanded to include a regulator. In this manner, it is possible to reduce the maximum output voltage. By way of example, this can be used if it is necessary to maintain up to 35 V at the input for a long period, and the downstream circuit components are subjected to a maximum of 38 V. A simple regulator can be realized with an adjustable shunt regulator, as illustrated in FIG. 5. By way of example, a potential shunt regulator could be the TL 431 or LMV 431. The circuit according to FIG. 5 differs from the circuit according to FIG. 4 in that the Zener diode is replaced by a shunt regulator IC1. As such, the shunt regulator serves as the means for the generation of a reference voltage. The reference electrode of the shunt regulator IC1 is connected to the center tap of a voltage divider which is connected between the source of the MOSFET T1 and the ground GND. The voltage divider is formed by the resistors R2 and R3.

The limit voltage can be very simply determined via the resistors R2 and R3. If the output voltage is below the adjusted limit voltage, the shunt regulator IC1 plays no role and the MOSFET is completely open. Only once the input voltage rises above the limit voltage does the shunt regulator IC1 regulate the gate voltage at the MOSFET T1, in such a manner that the output voltage corresponds to the adjusted limit voltage. In this manner, an output voltage is created which is independent of the input voltage and the individual MOSFET unit. If the resistors R2 and R3 and the shunt regulator are selected from units with tight tolerances and which are as non-temperature-dependent as possible, it is possible for the allowed long-term input voltage and the maximum allowed voltage of downstream circuit components to be close to each other. In this manner, it is possible to achieve a very good dynamic behavior of the overall circuit.

The circuit behaves in principle like a fully integrated low-drop regulator, wherein it is Possible—in contrast to a low-drop regulator—to design the [specifications of the] output voltage, the input voltage, and the limit voltage in a relatively free manner by a suitable selection of the components. In this way, the configuration dispenses with the serious limitations with regard to the available output voltages determined, by way of example, by fully integrated low-drop regulators.

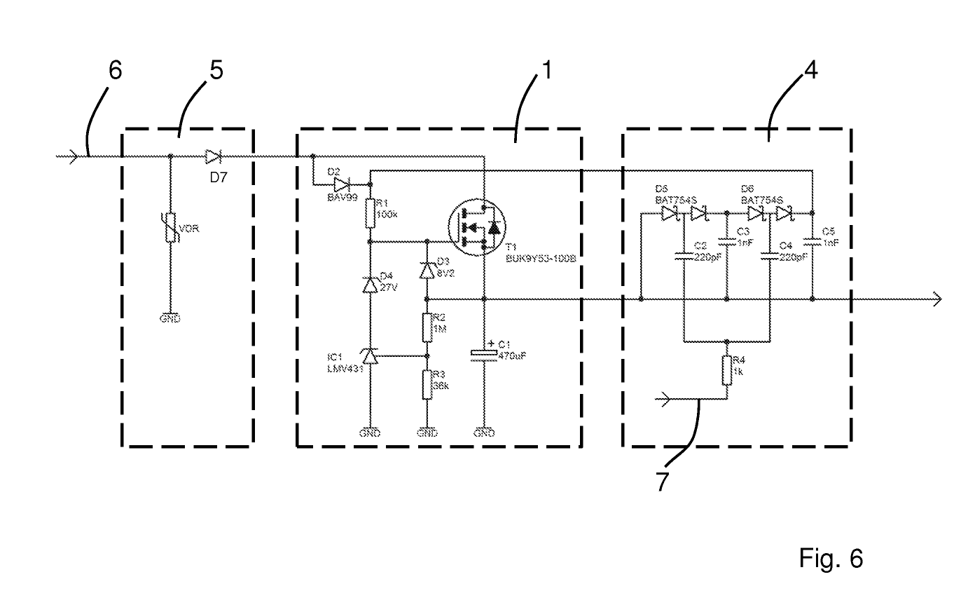

FIG. 6 shows a use of a protective circuit according to the invention in a multi-stage protection concept, whereby the protection against overvoltages enabled by the circuit is further improved. In addition to the protective circuit 1 according to the invention, a coarse protection 5 is connected upstream, which rapidly taps off rising overvoltages at the input 6 of the overall protective circuit. In this case, a varistor VDR is used which has a limit voltage of 70 V in the illustrated example. A diode D7 serves as a simple protection against reversal of polarity, and as protection against negative overvoltages. As an alternative to the diode D7, circuits with low voltage drops can also be used. By way of example, this could be a protective circuit as described in DE 10 2010 051 874.

The protective circuit 1 used in FIG. 6 differs from the protective circuit according to FIG. 5 in that a further Zener diode D4 (a second Zener diode as per the dependent claims) is connected between the gate of the MOSFET T1 and the shunt regulator IC1. In the embodiment illustrated in FIG. 6, the breakdown voltage of the Zener diode D4 is 27 V, and the limit voltage of the circuit is increased by this value. The shunt regulator IC 1 is formed by an LMV431. The voltage divider consists of a resistor R2 of 1 MΩ and a resistor R3 of 36 kΩ. The buffer capacitor C1 is a 470 μF capacitor. The further circuit elements of the protective circuit 1 are configured as already described by way of example in FIG. 4. The auxiliary voltage source 4 is formed by a charge pump. The charge pump is constructed with two stages, wherein a first stage having a double diode D5 and the capacitors D2 and D3 generates a voltage increase of approx. 2.5 V. A second stage having a double diode D6 and the capacitors C4 and C5 increases the voltage further, by approx. 2.5 V, such that the voltage generated by the auxiliary voltage source is approx. 5 V higher than the voltage at the source of the MOSFET T1, and therefore is approx. 5 V higher than the supply voltage Uᵢₙ at the input of the protective circuit 1, due to the very minimal voltage drop across the MOSFET T1. Exemplary configurations are illustrated in FIG. 6. The double diodes D5 and D6 can be implemented as BAT754S. The capacitors C2 and C4 are 220 pF, and the capacitors C3 and C5 are each 1 nF. The control voltage of the charge pump, which is applied to the line 7 and is connected to the central lead of the double diode D5 and D6 via a resistor R4 (1 kΩ), is a rectangular signal generated by a microcontroller. The auxiliary voltage source can also be used to supply further elements in addition to the protective circuit 1, for example a protection against reversal of polarity as per DE 10 2010 051 874. The rectangular signal which is coupled into the control line 7 can also be used for other circuits.

As regards further advantageous embodiments of the device according to the invention, reference is hereby made for the purpose of avoiding repetition to the general portion of the description and to the attached claims.

Finally, it is hereby expressly stated that the embodiments of the protective circuit according to the invention described above only serve to explain the claimed teaching, and the teaching is not restricted to the embodiments.

### LIST OF REFERENCE NUMBERS

T1 n-channel MOSFET
R1 resistor
D2 diode
D1 first Zener diode
D3 third Zener diode
C1 buffer capacitor
VDR varistor
D4 second Zener diode
D5 double diode
D6 double diode
D7 diode
Uᵢₙ supply voltage of the protective circuit
1 protective circuit
2 input of the protective circuit
3 output of the protective circuit
4 auxiliary voltage source
5 coarse protection
6 input
7 control line

1-9. (canceled)

10. A circuit for the protection of an electrical consumer against overvoltages, said circuit comprising:
an n-channel MOSFET (metal oxide semiconductor field-effect transistor) (T1); and
a means for the generation of a reference voltage,
wherein:
the means for the generation of a reference voltage is connected to the gate of the MOSFET (T1);
a supply voltage is applied at the input of the circuit; and
the gate is supplied with a voltage which is greater than the supply voltage due to the use of an auxiliary voltage source, in such a manner that the MOSFET (T1) opens.

11. A circuit according to claim 10, wherein the means for the generation of a reference voltage is a first Zener diode (D1).

12. A circuit according to claim 10, wherein:
the means for the generation of a reference voltage is a shunt regulator (IC1);
the reference electrode thereof is connected to the center tap of a voltage divider consisting of two resistors (R2 and R3); and
the voltage divider is connected between the source of the MOSFET (T1) and the ground.

13. A circuit according to claim 12, wherein, for the purpose of raising the limit voltage of the circuit, a second Zener diode (D4) is connected in series to the shunt regulator (IC1).

14. A circuit according to claim 10, wherein:
a charge pump functions as the auxiliary voltage source;
the charge pump generates an auxiliary voltage; and
the auxiliary voltage is 5 V.

15. A circuit according to claim 10, wherein the auxiliary voltage source is supplied from the voltage at the source of the MOSFET (T1).

16. A circuit according to claim 10, wherein a diode (D2) is connected to the supply voltage, and via an intermediate resistor (R1) to the gate of the MOSFET (T1), and the gate is controlled by said diode [(D2)] until the auxiliary voltage is introduced.

17. A circuit according to claim 10, wherein a third Zener diode (D3) is connected parallel to the source-gate path, by means of which the gate is protected from voltages which are too high and too low.

18. A circuit according to claim 10, wherein the limit voltage of the circuit is greater than 25 V.

19. A circuit according to claim 10, wherein the limit voltage of the circuit is greater than 30 V.
